(19) United States
(12) Patent Application Publication
(10) Pub. No.: US 2012/0307662 A1
(43) Pub. Date: Dec. 6, 2012

(54) METHOD FOR MONITORING AND INTELLIGENT CONTROL OF THE PARAMETERS IN RADIO NETWORKS

(75) Inventors: Anton Puolakka, Helsinki (FI); Kari Hyrkkö, Espoo (FI)

(73) Assignee: 7SIGNAL OY, Helsinki (FI)

(21) Appl. No.: 13/518,992

(22) PCT Filed: Dec. 22, 2010
(86) PCT No.: PCT/FI2010/051078

§ 371 Date: Aug. 10, 2012

(30) Foreign Application Priority Data
Dec. 23, 2009 (FI) 20096389

(51) Int. Cl. H04W 24/06

(52) U.S. Cl. 370/252

(57) ABSTRACT

A method and system for monitoring and intelligently controlling parameters that affect the operation of the network connection in wireless networks. Using monitoring elements, measurement data about the network is collected and stored in a so-called history base. The data can be processed by analysis in order to generate a prediction model giving an approximation of the network operation in the future. On the basis of the prediction model the parameters that affect the operation of the network connection in a network device can be controlled so as to maintain or improve the service level provided by the network. The measurements and the changes are made as a continuous process, so that the system can learn from the earlier situations and parameters so as to approach the optimal situation in the service provided by the network.

### FIELD OF THE INVENTION

The invention relates to the control and optimization of the operation of wireless communication networks.

### BACKGROUND OF THE INVENTION

In wireless communication networks it is important to secure good quality of the data traffic in the network and also the security factors in a data security sense. The quality can be verified and efficiently maintained by monitoring the operations of the wireless network using suitable apparatuses and procedures. By monitoring the operations, data is obtained that can be used to optimize and improve the operation of the network. Monitoring of the network reveals whether the desired connection or services are available or whether the quality of the connection is at a sufficient level. Wireless networks may also suffer from technology-related problems notably affecting the end user's experience of the quality of service.

The modern WLAN products based on a radio network controller-based solution have an elemental support for automatic optimization of the network. Many times, however, the automatic optimization causes more problems than solves them, which is evidenced for example by the fact that one often wants to switch off the automatic control during use. The most generally observed problem in controller-based solutions is the so-called pendulum effect where the automatism is not able to converge due to internal incongruities or changes in the immediate environment, but instead remains in a change cycle between two or more states. The most important reason for this is that the optimization of the wireless network is only based on momentary and local data about the radio environment supplied by the base station. The optimization parameters are typically only produced by the apparatus in the controller circuit. The real quality provided by the network and experienced by the end user is not used in the controlling of the network, and the decision-making is not based on finding the best result for the entire network.

In the prior art, the following arrangements, a.o., have been used in optimizing a wireless network. One way is to optimize the operation of the network automatically by the preceding WLAN controller. In this case the base stations of the network and data transmitted by them are monitored and the network is optimized on the basis of the obtained data. The optimization is only based on data obtained from the base stations in the controller circuit and the data used in the optimization is only indicative of the state of the network at the time of observation. Drawbacks of this method are that the optimization is only based on radiocentral data obtained from the base stations, in which case the user experience is not included in the measurements. In addition, the radio environment as a whole cannot be observed in the optimization. Further, a change in other than the controller base stations interferes with the optimization. Another risk in this method is that two or more adjacent controller networks that automatically change their parameters might not find a mutual balance. The other devices on free channels (such as, e.g., a baby monitor, wireless “tv cable”, rfid, bluetooth) only appear as noise. In addition, it is difficult for the user to verify the state of the network.

As another way, optimization based on user feedback has been used. In this case, the users of the network report on poor functioning of the network. The operator of the network controls the network on the basis of the general good practice and response. In this case there is a disadvantage that the user does not necessarily report on a poorly functioning network. In addition, disturbances in a wireless network are conventionally much more tolerated than in a fixed network. The user feedback may be indefinable, not necessarily describe the malfunction well or provide any device-related information. This procedure is also subject to delay; when the operator reacts, the error condition may already be gone. There may be many hours or even days between the feedback (or service request) and a reaction, in which case the original event is no longer measurable or otherwise observable. After optimization the end user typically does not report on the result of the optimization. Finally, this type of optimization is mainly based on the professional skill of the optimizer.

As a third optimizing method in prior art, a manual performance measurement of the network has been used. In this case the performance of the network is manually measured from different points in the coverage area of the network. From the measurement data, information about how the network can be improved is manually retrieved. After this the operator controls the settings of the radio network device-specifically. The result of the optimization can only be verified by new measurements. The measurement is based on one time and not on continuous monitoring. It is to be noted that the changes in the radio environment are continuous even if an organization did not have immediate neighbors. This type of optimization is mainly based on the professional skill of the optimizer to interpret the measured data and to use it as groundwork in the optimization of the network.

### OBJECTIVE OF THE INVENTION

An objective of the invention is to disclose a new type of a manner to improve and optimize the operation of wireless communication networks. Especially an objective of the invention is to solve the preceding problems of prior art.

### SUMMARY OF THE INVENTION

The present invention introduces a method for the monitoring and control of parameters in radio networks. The method is characterized in that data about the radio network and from network devices is collected, comprising collection of data by an active test that emulates a user, imitating an imaginary user's terminal equipment. In addition, the data is stored in a databank, content of the databank is analyzed in order to find desired regularities, a prediction model is generated for the operation of the radio network, and finally at least one parameter that affects the operation of a network connection is calculated and set in the method for at least one network device so as to maintain or improve the service level of the radio network.

In one embodiment of the invention, data about the radio network is collected directly from base stations, from the terminal equipment in the network, via separate monitoring stations, from controllers, from network management systems or from network devices that provide an open interface for reading data.

In one embodiment of the invention, a utility value is calculated for the effect of a parameter change and a new prediction model is generated and a new value calculated for said parameter so as to have a utility value corresponding to the new value that is lower than the utility value of the previous parameter change.

In one embodiment of the invention, radio signals are measured by a separate or integrated spectrum analyzer.

In one embodiment of the invention, the earlier parameters on the network devices are restored in a situation where the quality of service provided by the network has deteriorated after a parameter change.

In one embodiment of the invention, the effect of the base station distance is compensated for by performing a reference measurement from the user's direction and by calculating a ratio of the current signal level to the level of the reference measurement.

In one embodiment of the invention, the parameters that affect the operation of the network are controlled in order to achieve the service level defined in a service level agreement.

According to a second aspect of the present invention, the inventive idea includes a system that corresponds to the method. The system comprises at least one monitoring means in order to collect data about the radio network and from network devices, comprising collection of data by an active test that emulates a user, imitating an imaginary user's terminal equipment. In addition, the system comprises a databank in order to store the data, analysis means in order to analyze content of the databank to find desired regularities, said analysis means is in order to generate a prediction model for the operation of the radio network, and a controller is in order to calculate and set at least one parameter that affects the operation of a network connection in at least one network device so as to maintain or improve the service level of the radio network.

In one embodiment of the invention, the system further comprises at least one monitoring means in order to collect data about the radio network directly from base stations, from the terminal equipment in the network, via separate monitoring stations, from controllers, from network management systems or from network devices that provide an open interface for reading data.

In one embodiment of the invention, the system further comprises said analysis means in order to calculate a utility value for the effect of a parameter change and said analysis means in order to generate a new prediction model and calculate a new value for said parameter so as to have a utility value corresponding to the new value that is lower than the utility value of the previous parameter change.

In one embodiment of the invention, the system further comprises a separate or integrated spectrum analyzer in order to measure radio signals.

In one embodiment of the invention, the system further comprises said controller in order to restore the earlier parameters of the network devices in a situation where the quality of service provided by the network has deteriorated after a parameter change.

In one embodiment of the invention, the system further comprises said analysis means in order to compensate for the effect of the base station distance by performing a reference measurement from the user's direction and calculating a ratio of the current signal level to the level of the reference measurement.

In one embodiment of the invention, the system further comprises said controller in order to control the parameters that affect the operation of the network to achieve the service level defined in a service level agreement.

According to a third aspect of the present invention, the inventive idea includes a computer program that corresponds to the method for the monitoring and control of the parameters in radio networks. The computer program comprises program code arranged to perform the following steps when run on a data processing device:

collecting data about the radio network and from network devices, comprising collection of data by an active test that emulates a user, imitating an imaginary user's terminal equipment;

storing the data in a databank;

analyzing content of the databank in order to find desired regularities;

generating a prediction model for the operation of the radio network; and

calculating and setting at least one parameter that affects the operation of a network connection for at least one network device so as to maintain or improve the service level of the radio network.

The present invention provides for automatic fault correction in radio networks, especially WLAN, reaction to an unexpected and unpredictable change in the operation of the network, and optimization of the network traffic in radio transmitters and the respective control devices such as controllers.

The present invention includes measuring instruments capable of measuring the radio environment and acting as the client in the radio network, performing active tests that emulate the user in the network (for example the ping test, FTP transfer rate tests etc.). In the invention, the data about the state of the network can be retrieved from the system that controls the radio network or from the base stations of the network. The optimization of the network is based on data measured from the network using algorithms developed especially for optimization of the network. In calculating for the optimization of the network, the data obtained from the controllers and base stations is also used. In addition, the user can always obtain an outlook on the network state by the invention at the current as well as an earlier time as desired. The invention can be set to function round the clock each day of the week if desired. In addition, the user can control the operation of the invention. In the invention, also other communication networks than the network under consideration can be observed. Finally, the apparatus of the invention is able to verify the result of the optimization.

### LIST OF FIGURES

FIG. 1 presents one example of an apparatus used in the invention,

FIG. 2 presents an exemplary flow chart about the operation of an algorithm used in the invention,

FIG. 3a presents a reference value for the transfer rate as a function of the distance from the base station, and

FIG. 3b presents the measurement of the relative performance at different values of the received power.

### DETAILED DESCRIPTION OF THE INVENTION

The present invention describes a new solution for the optimization of wireless communication networks based on collection of data from the radio environment and the radio network by a continuous measurement method that observes all radio devices in the environment. In these measurements, the application level tests that measure the client experience have an essential role. The collection of data takes place by a well-known and generally used passive measurement (for example monitoring of traffic or spectral measurement) and by an active test that imitates the user (for example the so-called ping test), based on emulation of the user's actions at the application level. The application level measurements give a general view on the operating condition of the network as experienced by the user and, together with the basic measurements in the radio environment, gives a comprehensive idea of different events and the experienced quality of the network operation.

In one embodiment of the invention, the employed measuring devices include means specializing in continuous measurement (i.e. particular monitoring devices) and optionally base stations and terminal equipment of the wireless network to be monitored when data can be collected therefrom via open connections. The collected measurement data and the currently employed parameters can be stored in a history base.

By analyzing the stored data the operation of the wireless network can be improved and, at the best, the optimal operating situation can be found by observing the history data for a longer period. Reliability of the network operation optimization can be substantially improved by using the data about the service provider (the base station) and the user of the service (the client of the network).

The quality level of the network service after the optimization or error correction can be verified when new measurements are performed. In this case, the analysis of the data, the preparation of proposals for improvement and the control of the devices and control measurements are left out from the human work input included in the prior art. The system of the invention performs all these steps independently, whereby the analysis and control work performed by people is minimized.

The essential feature in the principle of the present invention is that the network and the close environment to be controlled can be continuously monitored in the method of the invention by measuring the radio environment, the devices of the radio network, the operation of a connected fixed network and the operation of the services attained via the network. The data is stored in a separate history base for analysis. In addition, data is retrieved in the invention from the network devices utilizing open interfaces. In the invention, these results are stored, adding this way to the number of the measurement points.

Further, the system of the invention produces procedures that improve the performance of the network by analyzing the data using different algorithms. These may encompass changing the parameter(s) that affect(s) the operation of the network connection(s) of one or more network devices in a preferred embodiment of the invention. In the invention, the radio network may also be reconfigured in order to improve the operation of the network. In one embodiment of the invention, the configuration of the parameters may be continuously performed, in which case the network operates optimally all the time. In another example of the invention, the configuration of the parameters can be performed according to the measurements of a desired time interval or point of time and, additionally, the configuration as such is set for a particular desired period.

In one embodiment of the invention, the performed changes and reasons for the performed changes can be conveyed to the operator of the network using an open documented interface.

In one embodiment of the invention, the measurements are continued and the same analysis performed on the results again after the configuration in the method. In addition, incongruities can be searched from the performed changes and the results. If the incongruities become more frequent or the results substantially deteriorate, the system may restore earlier, well-found configurations or parameters and inform the operator of the network of the apparent difficulties. The user of the system can set the operation mode of the invention to be fully restoring, partially restoring or always to search for a new configuration. The intention is that the need for change diminishes over each iteration cycle so as to converge and stabilize the parameters.

Execution of the network reconfiguration is, of course, optional in a sense that the method of the invention always produces the optimation proposals, but the proposals can only be conveyed to the operator without executing them in practice.

In the normal use of the invention, the network is continuously optimized. However, it is to be observed that there is no need for change in a well operating network. In addition, it is obvious that the need for change in the configuration or parameters that affect the operation of the network connection becomes evident only after important changes performed in the network.

In one example of the invention, the user has a possibility to define the desired target state in the continuously performed configuration of the network elements. It may be defined, for example, that the desired throughput of the network is achieved for 99.9% of the time.

In one embodiment, the system according to the present invention comprises radio network monitoring means; monitoring means management software; software for integration to the network devices; a databank; software analyzing the data of the databank and using it to generate references for new settings of the radio network; and a user interface.

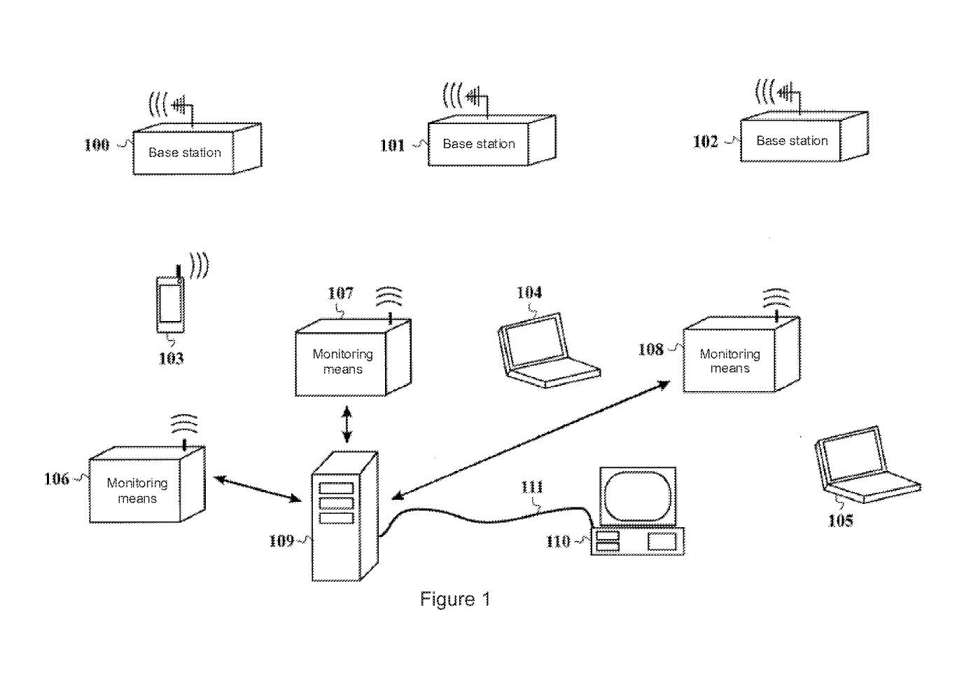

In the following, the parts of the system are described in more detail. In this connection reference is made to the example of the employed system presented by FIG. 1.

In this example of the system the network includes three base stations 100 to 102. The network is a WLAN in a preferred embodiment but it may also be another wireless network. The terminal equipment of the clients who use the network are represented in this example by a PDA (a palmtop computer) 103 and portable computers 104 to 105. There are three units of monitoring means (that may be separate monitoring stations or monitoring units integrated in other network devices) 106 to 108 located in the area of the network in this example. They can be situated on fixed locations or moved from one place to another if necessary. The function of the monitoring means 106 to 108 is to act as the client of the radio network (imitate the actual client) and measure the current signals in the surrounding radio environment. As the client of the network, the purpose of the monitoring means is to measure the performance of the radio network by running different application programs. This measurement category includes many different tests, such as “time of association to base station”, “up- and downlink FTP transmission” and “VoIP test call”. By using the radio receiver of the monitoring means the radio environment can be measured and the current signal and noise levels at the measurement site can be this way observed. A spectrum analyzer circuit can be installed on the monitoring means 106 to 108 as an accessory in order to give an even more accurate outlook on the radio environment.

In the system, a server 109 acting as a databank and analyzer of the data is additionally needed. In addition, monitoring means management software, the purpose of which is to control the network of the monitoring means and to collect measurement data from the monitoring means can be located on the server 109. The management software is also responsible for storing the measurement data in the databank. The databank is an element where all measurement data and setting attributes are stored in one embodiment of the invention. The databank may be a database of free distribution or a commercial solution. The databank can also be distributed in many different locations if necessary.

In addition, software for integration to the network devices is needed in the apparatus. This software can be installed on the server 109. The purpose of this software is to connect to the radio network management software or directly to the base stations 100 to 102 of the radio network.

Further, an essential part of the system of the invention is analysis software that analyzes the data and can be installed on the server 109 in a preferred embodiment. The analysis software analyzes the data stored in the databank by separately designed algorithms. As the final result of the analysis, procedures for improving the operation of the radio network are produced if necessary.

Finally, a computer 110 represents the user interface of the system which is the window to the system for an individual user. By the terminal 110 the state of the network to be optimized can be checked and a possibility to set parameters for the algorithms calculating the optimized parameter alternatives for the network devices from the stored data can be provided. Via the user interface 110 the user may also manage the network of the monitoring means 106 to 108 and the collection of data from third party network devices.

As an assembly, the parts of the system are integrated together by software connections or telecommunication protocols. The monitoring means 106 to 108, the third party network devices and the databank 109 are managed by telecommunication protocols. The rest of the system components are typically connected via software connections. The terminal 110 that represents the user interface may be connected to the server 109 via a fixed connection 111 or over the Internet, but the coupling between them is not limited merely to these modes. In one embodiment, the computers 109 and 110 may be integrated into one server to which the user has access.

The invention relates thus preferably to WLAN, but the usefulness of the invention is not merely restricted to WLAN.

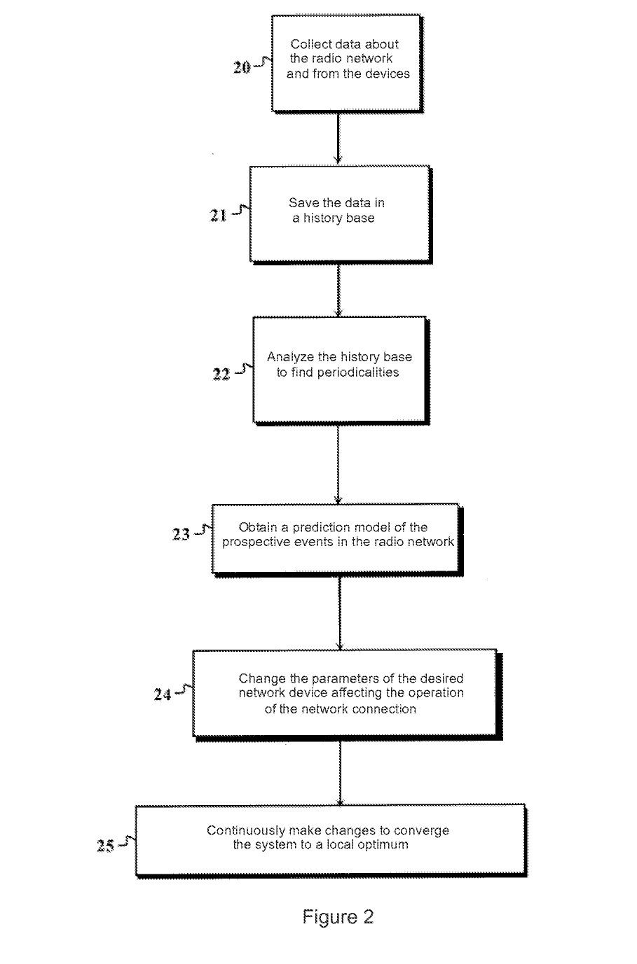

With reference to the prior description of the invention, FIG. 2 presents the preferred embodiment of the method of the present invention in the form of a flow chart. Via the monitoring means, data is collected directly from the network devices or, generally speaking, the current signals around each monitoring means are observed for example by an integrated spectrum analyzer. This step is represented in FIG. 2 by notation 20. After this, the data is moved to the server comprising a databank where the data is stored in a so-called history base 21. When there is sufficiently analyzable data in the history base, the data is subjected to analysis or mining 22 so as to discover periodicalities and events appearing in the quality of the network service for example regularly at a particular time of day. This can be executed by the analysis software based in the server. As the result of the analysis a prediction model 23 can be produced of how for example the capacity obtained from the base stations of the network should be distributed, how the network operates as a function of time, for example in the area of an office to be examined, or how the signal-to-noise ratio should be improved for the signal going out from the base station. In other words, the prediction model can give a good approximation for example of how the network will function in the near future or for example an estimate of the number of users connecting to the network in the near future.

After this, at least one parameter of the network or the devices therein is changed 24 if the system concludes a need for that on the basis of the prediction model. Typically, this applies to a parameter that relates to the signal transmission of a network element. The purpose of the change is in first place to improve the quality of service experienced by the user.

Finally, the parameter change process is made to learn in a sense that the measure of the achieved advantage is examined after the first effected parameter change. The process can be started from the beginning 20 and new changes in the parameters that affect the operation of the network connection of the elements can be calculated. The new change is made so as to approach the optimal situation in terms of the quality of service provided by the network, taking into account the state of the network at the time of observation and the prediction model for the near future. In other words, parameter changes are continuously and intelligently made in this example and, on this account, the configuration of the system converges to the optimal situation 25.

As one example of the application of the invention, the so-called two-step optimization can be mentioned. This may be executed for example by roughly controlling the load of the radio network in the first step so as to monitor and control the use of the network traffic radio frequencies. The parameters can be changed after a measurement so as to distribute the load of the network traffic as uniformly as possible after the control over the entire band to be examined. The system can be programmed so that after this the parameters are controlled at this rough level only in larger changes of the state. At other times, a finer control that may be a control over the parameters that affect the operation of the client terminal and/or base station network connection and obtained as a result of the preceding user emulation tests is performed.

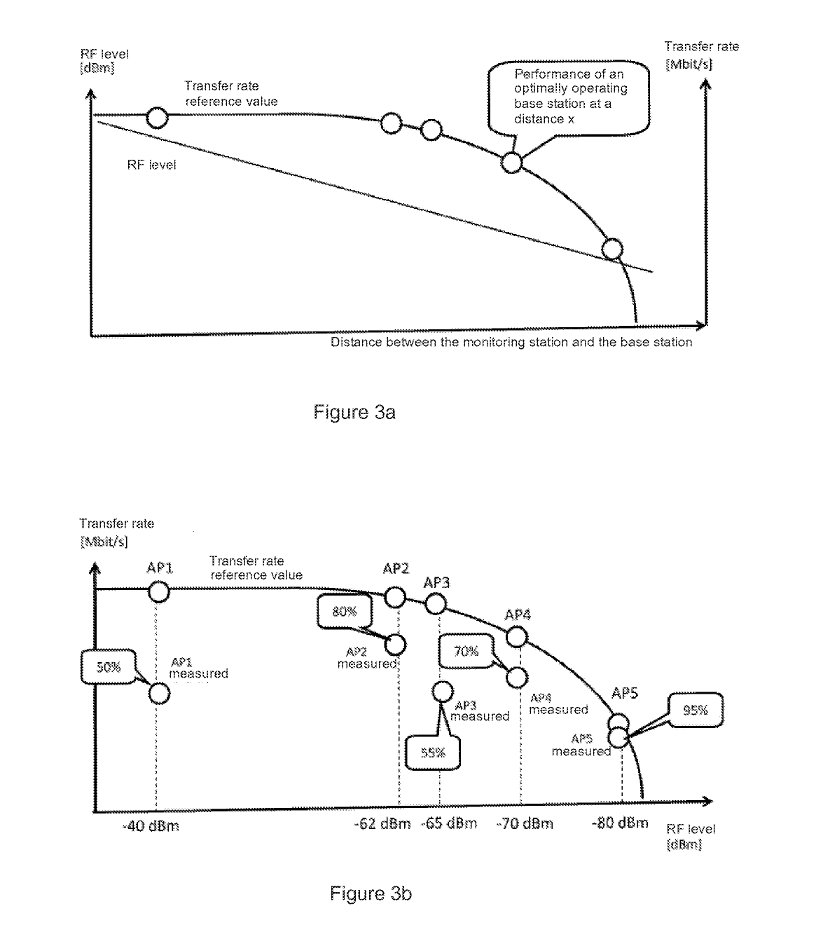

The distance between the base station and the monitoring means naturally affects the magnitude of the RF level as measured by the monitoring means. In other words, the measurement result achieved at the end of the end user deteriorates as the distance increases. There is therefore a need to calibrate the effect of the distance from the results. In this connection, reference is made to FIG. 3a. As seen from the figure, the RF signal level declines in an inversely proportional ratio to the distance of the receiver (in this case, the monitoring means). However, the transfer rate first remains constant as the distance increases but starts to decline after a threshold distance. By a reference measurement in a pure radio environment the reference values for the transfer rate can be measured by tests performed from the end user's direction. These are presented as circles in FIG. 3a. After this, the results in different base stations to be monitored can be compared to the reference values (i.e. not the absolute values). This eliminates the effect of distance from the results and gives a more reliable outlook on the quality of each base station operation. Finally, the operation of the network can be controlled and the parameters configured on the basis of this data.

Next, reference is made to FIG. 3b. Each base station has a reference result value in different measurements, depending on the intensity of the signal transmitted by the base station. The transfer rate reference values for five different base stations situated at different distances from the monitoring means are marked by circles (AP1-AP5) on the curve. The values of an application test measured at different times are represented in FIG. 3b by circles shown as “speech balloons”. The measured transfer rate in real terms is accordingly for example 50% of the ideal reference value regarding the base station AP1. This way, the value of the application test measured at different times can at the same time be compared against a target value set through the current signal level. The quality of the result and the quality of the operation of the base station are estimated on the basis of the target value to the measurement ratio, which is marked in the speech balloons in FIG. 3b. Finally, the operation of the network can be optimized by maximizing this relative performance result. The target values can be theoretically calculated or they can be measured. Further, the target values can vary by different device types, models and applications. All kinds of measurements may have target values, for example FTP, ping, VoIP MOS (Mean Opinion Score), SNR, retransmissions or data rates measurements. The fulfillment of the target values can be used in estimating the fulfillment of the service level agreement. On the basis of the fulfillment of the target values it is also possible to give alerts.

In one embodiment of the present invention, the parameters that affect the operation of the network (such as QoS parameters, “Quality of Service”) can be controlled in order to achieve the quality of service defined in the service level agreement (SLA) which is, accordingly, the target. In the current wireless networks it is possible to determine different quality categories for different types of traffic. Exemplary quality categories for traffic may include “VoIP”, “Video” and “Best Effort”. These may be distributed for example so as always to provide 60% of the band to the VoIP, 35% to the video, and the rest 5% for other traffic.

The network may have a valid service level agreement, or an arrangement where the VoIP calls function for example 99.9% of the time at a speech quality corresponding to at least a MOS category of 3.5 can be implemented. Naturally, also other values and arrangements can be set for the service level in this connection.

The system described in the invention can act as a so-called SLA meter storing data about how the VoIP calls function in the network to be managed for example by tests that model the user's actions. When enough data has been collected, it can be used to observe whether for example the VoIP quality of service is realized as desired.

The system described in the invention can also continuously optimize the parameters of the network elements (such as QoS parameters) so as to come to the pursued service level or as close to that as possible in the entire network. There may be valid service levels at many different levels at the same time. In the normal http traffic a particular throughput must be obtained for example 95% of the time, whereas VoIP calls must function with good sound quality for example 99.99% of the time. In order to realize both of these targets, the system that is the object of the invention can also change the QoS settings of the wireless network in order to come to the desired service levels or as close to them as possible on all levels of the agreement. The target service level may vary for example by areas, applications and points of time.

The invention is not limited merely to the exemplifying embodiments referred to above; instead, many variations are possible within the scope of the inventive idea defined by the claims.

1. A method for monitoring and control of parameters in radio networks, characterized in that the method comprises the steps of:
collecting data about the radio network and from network devices, comprising collection of data by an active test that emulates a user, imitating an imaginary user's terminal equipment, by measuring the radio environment, the devices of the radio network, the operation of a connected fixed network and the operation of the services attained via the network;
storing the data in a databank;
analyzing content of the databank in order to find desired regularities;
generating as the result of the analysis a prediction model for the quality of service provided by the network in the near future; and if the system concludes a need for that on the basis of the prediction model,
calculating and setting at least one parameter that affects the operation of a network connection for at least one network device so as to maintain or improve the service level of the network.

2. The method according to claim 1, characterized in that the method further comprises the step of:
collecting data about the radio network directly from base stations, from the terminal equipment in the network, via separate monitoring stations, from controllers, from network management systems or from network devices that provide an open interface for reading data.

3. The method according to claim 1, characterized in that the method further comprises the steps of:
calculating a utility value for the effect of a parameter change; and
generating a new prediction model and calculating a new value for said parameter so as to have a utility value corresponding to the new value that is lower than the utility value of the previous parameter change.

4. The method according to claim 1, characterized in that the method further comprises the step of:
measuring the radio signals by a separate or integrated spectrum analyzer.

5. The method according to claim 1, characterized in that the method further comprises the step of:
restoring the earlier parameters on the network devices in a situation where the quality of service provided by the network has deteriorated after an effected parameter change.

6. The method according to claim 1, characterized in that the method further comprises the step of:
compensating for the effect of the base station distance by performing a reference measurement from the user's direction and by calculating a ratio of the current signal level to the level of the reference measurement.

7. The method according to claim 1, characterized in that the method further comprises the step of:
controlling the parameters that affect the operation of the network in order to achieve the service level defined in a service level agreement.

8. A system for monitoring and control of parameters in radio networks, characterized in that the system comprises:
at least one set of monitoring means (106, 107, 108) configured to collect data about the radio network and from network devices, comprising collection of data by an active test that emulates a user, imitating an imaginary user's terminal equipment, by measuring the radio environment, the devices of the radio network, the operation of a connected fixed network and the operation of the services attained via the network;
a databank (109) configured to store the data;
analysis means (109) configured to analyze content of the databank to find desired regularities;
said analysis means (109) configured to generate as the result of the analysis a prediction model for the quality of service provided by the network in the near future; and if the system concludes a need for that on the basis of the prediction model,
a controller (109) is configured to calculate and set at least one parameter that affects the operation of a network connection of at least one network device so as to maintain or improve the service level of the network.

9. The system according to claim 8, characterized in that the system further comprises:
at least one set of monitoring means (106, 107, 108) configured to collect data about the radio network directly from base stations, from the terminal equipment in the network, via separate monitoring stations, from controllers, from network management systems or from network devices that provide an open interface for reading data.

10. The system according to claim 8, characterized in that the system further comprises:
said analysis means (109) configured to calculate a utility value for the effect of a parameter change; and
said analysis means (109) configured to generate a new prediction model and calculate a new value for said parameter so as to have a utility value corresponding to the new value that is lower than the utility value of the previous parameter change.

11. The system according to claim 8, characterized in that the system further comprises:
a separate or integrated spectrum analyzer configured to measure radio signals.

12. The system according to claim 8, characterized in that the system further comprises:
said controller (109) configured to restore the earlier parameters on the network devices in a situation where the quality of service provided by the network has deteriorated after an effected parameter change.

13. The system according to claim 8, characterized in that the system further comprises:
said analysis means (109) configured to compensate for the effect of the base station distance by performing a reference measurement from the user's direction and calculating a ratio of the current signal level to the level of the reference measurement.

14. The system according to claim 8, characterized in that the system further comprises:
said controller (109) configured to control the parameters that affect the operation of the network to achieve the service level defined in a service level agreement.

15. A computer program for monitoring and control of parameters in radio networks, characterized in that the computer program comprises program code arranged to perform the following steps when executed on a data processing device:
collecting data about the radio network and from network devices, comprising collection of data by an active test that emulates a user, imitating an imaginary user's terminal equipment, by measuring the radio environment, the devices of the radio network, the operation of a connected fixed network and the operation of the services attained via the network;
storing the data in a databank;
analyzing content of the databank in order to find desired regularities;
generating as the result of the analysis a prediction model for the quality of service provided by the network in the near future; and if the system concludes a need for that on the basis of the prediction model,
calculating and setting at least one parameter that affects the operation of a network connection for at least one network device so as to maintain or improve the service level of the network.

16. The method according to claim 2, characterized in that the method further comprises the steps of:
calculating a utility value for the effect of a parameter change; and
generating a new prediction model and calculating a new value for said parameter so as to have a utility value corresponding to the new value that is lower than the utility value of the previous parameter change.

17. The method according to claim 2, characterized in that the method further comprises the step of:
measuring the radio signals by a separate or integrated spectrum analyzer.

18. The system according to claim 9, characterized in that the system further comprises:
said analysis means (109) configured to calculate a utility value for the effect of a parameter change; and
said analysis means (109) configured to generate a new prediction model and calculate a new value for said parameter so as to have a utility value corresponding to the new value that is lower than the utility value of the previous parameter change.

19. The system according to claim 9, characterized in that the system further comprises:
a separate or integrated spectrum analyzer configured to measure radio signals.
